(19) United States
(12) Patent Application Publication
(10) Pub. No.: US 2025/0058799 A1
(43) Pub. Date: Feb. 20, 2025

(54) VEHICLE CONTROL DEVICE

(71) Applicant: HITACHI ASTEMO, LTD., Hitachinaka-shi, Ibaraki (JP)

(72) Inventors: Ryo INABA, Tokyo (JP); Tatsuhiko MONJI, Hitachinaka-shi, Ibaraki (JP)

(73) Assignee: HITACHI ASTEMO, LTD., Hitachinaka-shi, Ibaraki (JP)

(21) Appl. No.: 18/719,382

(22) PCT Filed: Aug. 15, 2022
(86) PCT No.: PCT/JP2022/030869

§ 371 Date: Jun. 13, 2024

(30) Foreign Application Priority Data
Dec. 15, 2021 (JP) 2021-203511

(51) Int. Cl. B60W 60/00

(52) U.S. Cl. CPC B60W 60/0011; B60W 60/0027; B60W 2520/10; B60W 2540/18; B60W 2554/4046

(57) ABSTRACT

A vehicle control device includes: a travel profile information generation unit that indicates a travel state of a host vehicle; a three-dimensional object behavior prediction unit that predicts an behavior of a three-dimensional object; a risk map generation unit that generates a risk map indicating a travel safety degree of the host vehicle on the basis of a prediction result of the behavior of the three-dimensional object and the travel profile information; a driving planning unit that calculates a priority indicating a degree to which the host vehicle is to preferentially make a selection; and a trajectory arbitration unit that selects a target trajectory of the host vehicle on the basis of the risk map and the priority.

### TECHNICAL FIELD

The present invention relates to a vehicle control device that controls a vehicle such as an automobile.

### BACKGROUND ART

Conventionally, for example, as disclosed in PTL 1, there has been developed a technique of deciding each of existence time ranges of a host vehicle and an environmental element with respect to each position around the host vehicle in a road environment where a traffic participant vehicle such as another vehicle exists, generating a travel risk map representing a travel risk level around the host vehicle on the basis of the existence time ranges, and supporting driving of the host vehicle.

### CITATION LIST

### Patent Literature

PTL 1: Japanese Patent No. 6622148

### SUMMARY OF INVENTION

### Technical Problem

In the conventional technique described in PTL 1, the existence time range of the host vehicle with respect to each position around the host vehicle is decided in consideration of the current vehicle speed and acceleration of the host vehicle, the travel trajectory plan, and the like. However, in a case where changes in these at future time are large, the existence time range of the host vehicle also greatly changes, and thus, a risk level with respect to the actual traveling state of the host vehicle greatly deviates from the generated traveling risk map. In such a situation, the driving support of the host vehicle cannot be appropriately performed, and safety (comfort) and ride comfort may deteriorate.

In view of this, an object of the present invention is to provide a vehicle control device capable of achieving both safety and ride comfort of an automatic driving vehicle and performing automatic driving with improved reliability.

### Solution to Problem

A vehicle control device includes: a travel profile information generation unit that generates travel profile information indicating a travel state of a host vehicle for each of a plurality of possible target behavior candidates taken by the host vehicle; a three-dimensional object behavior prediction unit that predicts an behavior of a three-dimensional object existing around the host vehicle; a risk map generation unit that generates a risk map indicating a travel safety degree of the host vehicle for each position around the host vehicle on the basis of a prediction result of the behavior of the three-dimensional object by the three-dimensional object behavior prediction unit and the travel profile information; a driving planning unit that calculates, for each of the plurality of target behavior candidates, a priority indicating a degree to which the host vehicle is to preferentially make a selection; and a trajectory arbitration unit that selects, as a target trajectory of the host vehicle, a trajectory corresponding to one of the plurality of target behavior candidates on the basis of the risk map and the priority.

### Advantageous Effects of Invention

According to the present invention, it is possible to provide a vehicle control device capable of achieving both safety and ride comfort of an automatic driving vehicle and performing automatic driving with improved reliability.

### BRIEF DESCRIPTION OF DRAWINGS

FIG. 1 is a block diagram illustrating a configuration of a traveling drive system and a sensor of an automatic driving traveling vehicle according to a first embodiment of the present invention.

FIG. 2 is a block diagram illustrating a configuration of a control system for automatic driving provided in a vehicle.

FIG. 3 is a block diagram illustrating a configuration of a risk map generation unit in FIG. 2.

FIG. 4 is a block diagram illustrating a configuration of a base profile generation unit in FIG. 3.

FIG. 5 is a block diagram illustrating a configuration of an automatic driving planning unit in FIG. 2.

FIG. 6 is a block diagram illustrating a configuration of a lane change trajectory generation unit in FIG. 5.

FIG. 7 is a schematic diagram of a risk map generated on the basis of a base profile.

FIG. 8 is a block diagram illustrating a configuration of a lane change state management unit in FIG. 6.

FIG. 9 is a block diagram illustrating a configuration of a lane change start determination state step in FIG. 8.

FIG. 10 is a block diagram illustrating a configuration of a lane change execution state step in FIG. 8.

FIG. 11 is a block diagram illustrating a configuration of a lane change completion state step in FIG. 8.

FIG. 12 is a block diagram illustrating a configuration of a lane change cancellation state step in FIG. 8.

FIG. 13 is an explanatory diagram illustrating movement of a vehicle according to the first embodiment of the present invention.

FIG. 14 is a block diagram illustrating a configuration of a base profile generation unit according to the first embodiment of the present invention.

FIG. 15 is an explanatory diagram illustrating the number of generated base profiles based on LC priority.

FIG. 16 is an explanatory diagram illustrating the number of generated base profiles based on LC priority.

FIG. 17 is an explanatory diagram illustrating the number of generated base profiles based on LC priority.

FIG. 18 is an explanatory diagram illustrating movement of a vehicle according to a second embodiment of the present invention.

FIG. 19 is an explanatory diagram illustrating movement of a vehicle according to a first modification.

FIG. 20 is an explanatory diagram illustrating movement of a vehicle according to a second modification.

Hereinafter, embodiments of the present invention will be described with reference to the drawings. The following description and drawings are examples for describing the present invention, and are omitted and simplified as appropriate for the sake of clarity of description. The present invention can be carried out in various other forms. Unless otherwise specified, each component may be singular or plural.

The position, size, shape, range, and the like of each component illustrated in the drawings may not represent the actual position, size, shape, range, and the like in order to facilitate understanding of the invention. Therefore, the present invention is not necessarily limited to the position, size, shape, range, and the like disclosed in the drawings.

### FIRST EMBODIMENT OF PRESENT INVENTION AND OVERALL CONFIGURATION

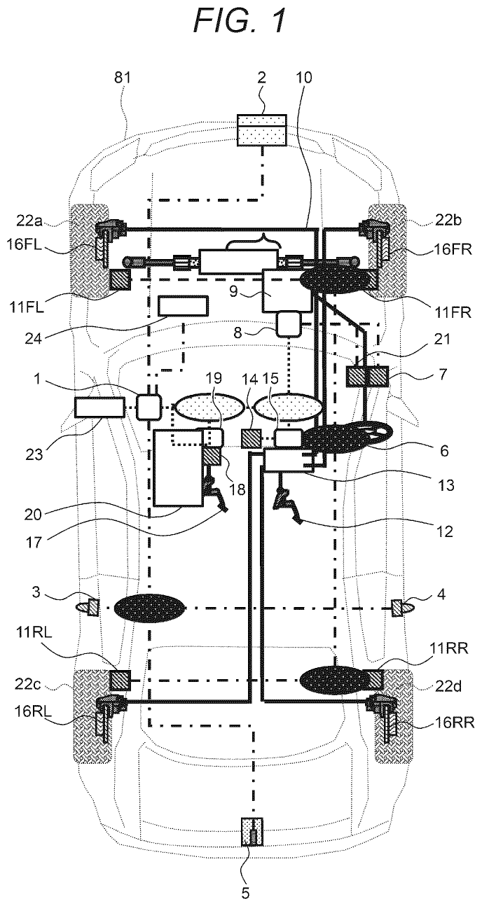

### FIG. 1

A vehicle 81 includes a steering control mechanism 10, a brake control mechanism 13, and a throttle control mechanism 20 for controlling each of the traveling direction and the speed of the vehicle 81, and a vehicle traveling control device 1 for integrally controlling them. In addition, the vehicle 81 includes a steering control device 8, a braking control device 15, an acceleration control device 19, and a display device 24. Note that as for the wheels included in the vehicle 81, an FL wheel 22a means a left front wheel, FR wheel 22b means a right front wheel, an RL wheel 22c means a left rear wheel, and an RR wheel 22d means a right rear wheel.

The vehicle traveling control device 1 calculates command values for the steering control mechanism 10, the brake control mechanism 13, and the throttle control mechanism 20, and transmits the command values to the steering control device 8, the braking control device 15, and the acceleration control device 19, respectively. The steering control device 8 controls the steering control mechanism 10 on the basis of the command values from the vehicle traveling control device 1, and changes the steering angles of the FL wheel 22a and the FR wheel 22b to control the traveling direction of the vehicle 81. The braking control device 15 controls the brake control mechanism 13 on the basis of the command values from the vehicle traveling control device 1, and adjusts the brake force distribution of each wheel included in the vehicle 81 to decelerate the vehicle 81. The acceleration control device 19 controls the throttle control mechanism 20 on the basis of the command values from the vehicle traveling control device 1, and adjusts the torque output of an engine to controls the acceleration of the vehicle 81. The display device 24 displays, to a driver, the travel plan of the vehicle 81, the behavior prediction of the moving object existing in the periphery, and the like.

The vehicle 81 includes sensors 2, 3, 4, and 5 that perceive the outside world. For example, the sensors 2, 3, 4, and 5 are a front camera 2, left and right side laser radars 3 and 4, and a rear millimeter wave radar 5, respectively. In addition, a communication device 23 included in the vehicle 81 performs road-to-vehicle communication to acquire information on another vehicle existing around the vehicle 81. The sensor information and the communication information thereof are input to the vehicle traveling control device 1, and a relative distance and a relative speed between the vehicle 81 and another vehicle around the vehicle can be detected.

Note that although a combination of the sensors 2 to 5 is illustrated as an example of the sensor configuration, the sensor configuration is not limited thereto, and may be a combination with an ultrasonic sensor, a stereo camera, an infrared camera, or the like.

In addition, although not illustrated, the vehicle traveling control device 1 includes, for example, a central processing unit (CPU), a read only memory (ROM), a random access memory (RAM), and an input/output device. The ROM stores a process flow regrading vehicle traveling control described later. In accordance with the generated travel plan, the vehicle traveling control device 1 calculates a command value for each actuator for controlling vehicle travel, such as the steering control mechanism 10, the brake control mechanism 13, and the throttle control mechanism 20 as described above.

The steering control device 8, the braking control device 15, and the acceleration control device 19 receive the command value of the vehicle traveling control device 1, and control the actuators 10, 13, and 20 on the basis of the command value.

### (Brake Operation)

The operation of the brake of the vehicle 81 will be described. When the driver steps on a brake pedal 12 while driving the vehicle 81, a stepping force is boosted by a brake booster, and a hydraulic pressure corresponding to the stepping force is generated by a master cylinder (not illustrated). The generated hydraulic pressure is supplied to a wheel cylinder 16 via the brake control mechanism 13.

The wheel cylinders 16 include wheel cylinders 16FL to 16RR corresponding to the left and right front wheels and the left and right rear wheels, respectively, and include cylinders, pistons, pads, and the like. In the wheel cylinder 16, a piston is propelled by the hydraulic fluid (the hydraulic pressure generated above) supplied from a master cylinder 9, and the pad connected to the piston is pressed against a disk rotor. Note that the disk rotor rotates together with the wheel 22. Therefore, the brake torque acting on the disk rotor becomes a brake force acting between the wheel 22 and a road surface. According to the above operation, the braking force can be generated in each of the wheels 22a to 22d according to the brake pedal operation of the driver.

Similarly to the vehicle traveling control device 1, the braking control device 15 includes, for example, a CPU, a ROM, a RAM, and an input/output device. The vehicle 81 includes a sensor combine 14 capable of detecting longitudinal acceleration, lateral acceleration, and a yaw rate, and wheel speed sensors 11FL to 11RR installed on the respective wheels. A brake force command and a sensor signal transmitted from a steering wheel angle detection device 21 via the steering control device 8 are input to the braking control device 15. The braking control device 15 estimates the spin, the drift-out, and the lock of the wheel of the host vehicle 81 on the basis of the information acquired from these commands and signals, and causes the braking force of the wheel to be generated so as to suppress them.

In addition, the braking control device 15 is connected to the brake control mechanism 13 having a pump and a control valve, and takes on the role of causing an arbitrary braking force to be generated on each of the wheels 22a to 22d independently of the brake pedal operation of the driver so as to enhance the steering stability of the driver.

In addition, the vehicle traveling control device 1 can cause an arbitrary brake force to be generated in the vehicle 81 by communicating a brake command to the braking control device 15. Accordingly, braking is automatically performed in automatic driving in which the operation of the driver does not occur. Note that the role of automatically braking the vehicle 81 is not limited to the braking control device 15, and may be performed by using another actuator such as a brake-by-wire.

### (Steering Operation)

Next, a steering operation will be described. In a state where the driver is driving the vehicle 81, when the driver turns a steering wheel 6, the steering torque and the steering wheel angle input via the steering wheel 6 are detected by a steering torque detection device 7 and the steering wheel angle detection device 21, respectively. On the basis of the detected information, the steering control device 8 controls a motor to generate assist torque.

Note that similarly to the vehicle traveling control device 1, the steering control device 8 includes, for example, a CPU, a ROM, a RAM, and an input/output device. The steering control mechanism 10 is movable by the resultant force of the steering torque of the driver and the assist torque by the motor, and the front wheel moves (turns) to the left or right. According to the turning angle (steering angle) of the front wheel, a reaction force from the road surface is transmitted to the steering control mechanism 10, and the degree of steering is transmitted as the road surface reaction force to the driver.

The steering control device 8 can control the steering control mechanism 10 by causing torque by the motor to be generated independently of the steering operation by the driver. Therefore, the vehicle traveling control device 1 can control the front wheel to an arbitrary turning angle by communicating the steering force command to the steering control device 8, and takes on the role of automatically performing steering in the automatic driving in which the operation of the driver does not occur. Note that the role of automatically performing steering is not limited to the steering control device 8, and may be taken by another actuator such as a steer-by-wire.

### (Accelerator Operation)

Next, the operation of the accelerator will be described. The depression amount of an accelerator pedal 17 by the driver is detected by the stroke sensor 18 and input to the acceleration control device 19. Similarly to the vehicle traveling control device 1, the acceleration control device 19 includes, for example, a CPU, a ROM, a RAM, and an input/output device. The acceleration control device 19 adjusts a throttle opening according to the depression amount of the accelerator pedal 17 to control the engine. Accordingly, the vehicle 81 can be accelerated according to the accelerator pedal operation of the driver.

In addition, the acceleration control device 19 can control the throttle opening independently of the accelerator operation of the driver. Therefore, the vehicle traveling control device 1 can causes the vehicle 81 to generate an arbitrary acceleration by outputting an acceleration command to the acceleration control device 19. Accordingly, in the automatic driving in which the operation of the driver does not occur, the vehicle traveling control device 1 takes on the role of automatically performing acceleration.

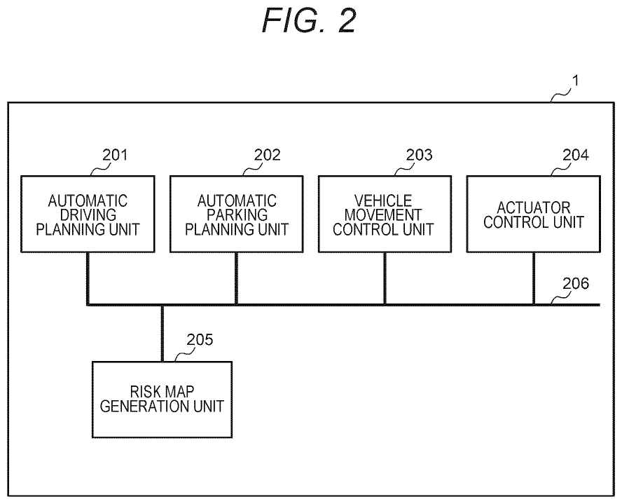

### FIG. 2

A vehicle control device 1 that plays a central role in a control system for automatic driving includes an automatic driving planning unit 201 that plans an operation of a host vehicle 81 to move the host vehicle 81 to a destination by automatic driving and generates a target trajectory, an automatic parking planning unit 202 that plans an operation of the host vehicle 81 to automatically park the host vehicle in a parking frame in a parking lot or the like, a vehicle movement control unit 203 that generates a command value for controlling a vehicle movement, an actuator control unit 204 that controls each actuator such as an engine, a brake, and a steering, and a risk map generation unit 205 that generates a travel risk level around the host vehicle 81 on the basis of an assumed behavior of the host vehicle 81.

Since the automatic driving planning unit 201, the automatic parking planning unit 202, the vehicle movement control unit 203, and the actuator control unit 204 are implemented on different controllers, a vehicle network 206 for performing communication between the controllers is provided. However, the vehicle network 206 is not limited to wired connection, and may be wireless connection.

In addition, as a method of implementation on each controller, the automatic driving planning unit 201 and the automatic parking planning unit 202 may be implemented on the same hardware. In addition, the actuator control unit 204 may be implemented on different types of hardware such as an engine control controller and a brake control controller.

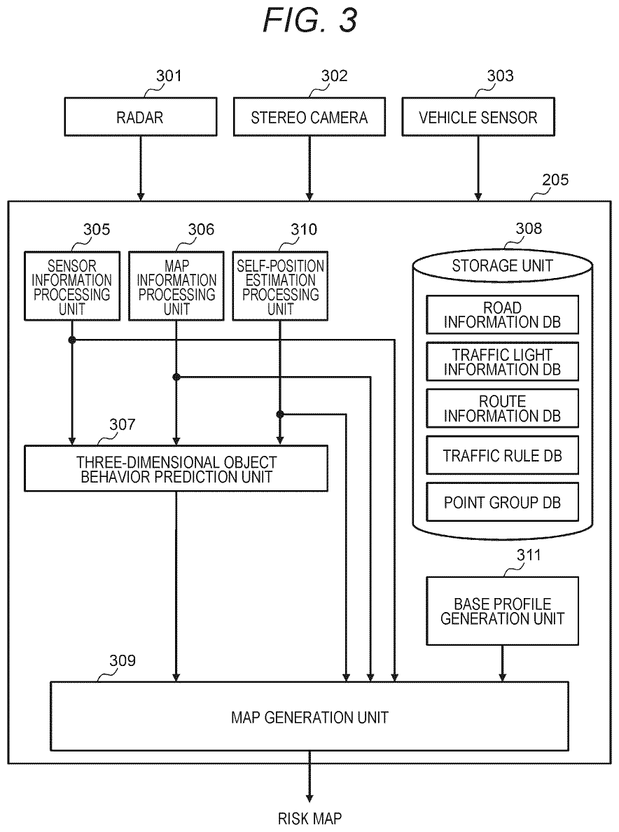

### FIG. 3

The risk map generation unit 205 acquires information from a radar 301, a stereo camera 302, and a vehicle sensor 303.

The radar 301 is the left and right side laser radars 3 and 4 or the rear millimeter wave radar 5 (see FIG. 1), and is a sensor that perceives the outside world. Radio waves and laser light are emitted toward an object, and the reflected waves thereof or scattered light with respect to laser irradiation emitted in a pulse shape is measured to measure a distance and a direction to the object. The stereo camera 302 is the front camera 2 (see FIG. 1), and simultaneously photographs an object outside the host vehicle from a plurality of different directions to record information in the depth direction.

The vehicle sensor 303 is the combine sensor 14 or the wheel speed sensors 11FL to 11RR (see FIG. 1), and is a group of sensors that can not only measure the speed of the host vehicle and the number of revolutions of the tire, but also detect the state of the host vehicle, such as information obtained by calculating the average position of the automatic driving vehicle using a global navigation satellite system (GNSS), destination information input by an occupant of the automatic driving vehicle using a navigation system as an interface, and destination information designated by an operator or the like at a remote location using wireless communication such as a telephone line.

The risk map generation unit 205 includes, as functional units, a sensor information processing unit 305, a map information processing unit 306, a self-position estimation processing unit 310, a storage unit 308, a three-dimensional object behavior prediction unit 307, and a map generation unit 309.

The sensor information processing unit 305 detects a three-dimensional object existing around the host vehicle 81 on the basis of the information of the environment around the host vehicle input from each sensor of the radar 301 and the stereo camera 302, and generates three-dimensional object information indicating the position and movement of the three-dimensional object. At this time, the sensor information processing unit 305 calculates the position and movement of each three-dimensional object on the basis of the information of the position and speed of the host vehicle input from the vehicle sensor 303. The sensor information processing unit 305 extracts attribute information, a current position, and a current speed vector of a three-dimensional object such as a parked vehicle, a pedestrian, and a bicycle around the host vehicle that may move in the future even if the speed obtained at the current time is 0, and generates the three-dimensional object information.

The storage unit 308 includes a road information DB that records information on a road from a point where the host vehicle starts automatic driving to a target point and roads around the road, a traffic light information DB that records information on traffic light installed on a road, a route information DB that records route information from a current position to the target point, a traffic rule DB that records a traffic rule of a section where the host vehicle travels, and a point group DB that is used by the self-position estimation processing unit 310 and records, as three-dimensional coordinate data, information on a road surface and a periphery of a road.

The map information processing unit 306 acquires the road information (lane center line information) and the traffic light information stored in the storage unit 308, and organizes the lighting information and the like of the traffic light through which the host vehicle 81, which is an automatic driving vehicle, is scheduled to pass so that the information can be used for the automatic driving control of the host vehicle 81. In this way, the automatic driving of the host vehicle is executed.

On the basis of information on the environment around the host vehicle and information on the host vehicle 81 obtained by a plurality of sensors (the radar 301, the stereo camera 302, the vehicle sensor 303) provided in the host vehicle 81 (the steering angle, the vehicle speed, the information obtained by the GNSS, and the like of the vehicle) and the point group DB of the storage unit 308, the self-position estimation processing unit 310 estimates a location where the host vehicle exists.

Information on the host vehicle, three-dimensional object information around the host vehicle, map information, and the like obtained by the sensor information processing unit 305, the map information processing unit 306, and the self-position estimation processing unit 310 are input to the three-dimensional object behavior prediction unit 307. The three-dimensional object behavior prediction unit 307 calculates future predicted position and speed information of each three-dimensional object on the basis of the input information.

For example, the three-dimensional object behavior prediction unit 307 predicts a position R(X(T), Y(T)) Of each three-dimensional object at a future time T on the basis of the three-dimensional object information in order to grasp the movement of each moving object. As a prediction method, in a case where a current position Rn0 (Xn(0), Yn(0)) and a current velocity Vn(Vxn, Vyn) of the three-dimensional object are set, a prediction calculation is performed on the basis of following Equation (1) of linear prediction.

$$Rn ( Xn ( T ) , Yn ( T ) ) = Vn ( Vxn , Vyn ) \times T + Rn 0 ( Xn ( 0 ) , Yn ( 0 ) ) \qquad Equation ( 1 )$$

The calculation method here assumes (limits) uniform linear motion in which each three-dimensional object around the host vehicle moves while maintaining the current speed in the future time. This method makes it possible to predict the behavior of the three-dimensional object existing around the host vehicle. In addition, it is possible to omit calculations including infinite conditions, reduce a calculation load, and predict the behaviors of many three-dimensional objects in a short time.

In addition, the three-dimensional object behavior prediction unit 307 may be configured by a learned neural network model. In this case, the position and speed information of another vehicle output from the sensor information processing unit 305 and the image information obtained by the camera are input to the three-dimensional object behavior prediction unit 307, so that the value of the coupling coefficient of the network is learned and decided such that an output corresponding to the input is obtained for the input information on the basis of learning data prepared in advance. Accordingly, it is possible to obtain the prediction result of the position and speed information of each three-dimensional object existing around the host vehicle in the future time and the reliability of the prediction result. Accordingly, the prediction reliability with respect to the behavior of the three-dimensional object around the host vehicle can be used for updating the behavior (target behavior) that the host vehicle is to take in the future in the automatic driving.

Note that a blinker action (lighting of a direction indicator) of another existing vehicle may be included as a pattern for deciding the reliability. For example, in the case of a positional relationship in which the driver or the sensor of another vehicle 1201 is in a blind spot, there is a possibility that the another vehicle 1201 is not able to confirm the direction indicator of the host vehicle 81, and in that case, it is necessary to generate a risk map accompanied by acceleration/deceleration.

The map generation unit 309 acquires the behavior prediction result of the three-dimensional object around the host vehicle from the three-dimensional object behavior prediction unit 307, and acquires the environmental information (including lane center line information, object information that is the prediction result of a behavior of a surrounding object, and the like) from each of the sensor information processing unit 305, the map information processing unit 306, and the self-position estimation processing unit 310. Further, the map generation unit 309 acquires a base profile candidate representing the predicted traveling state of the host vehicle from the base profile generation unit 311 (details will be described later). Accordingly, the map generation unit 309 generates a risk map for each base profile candidate.

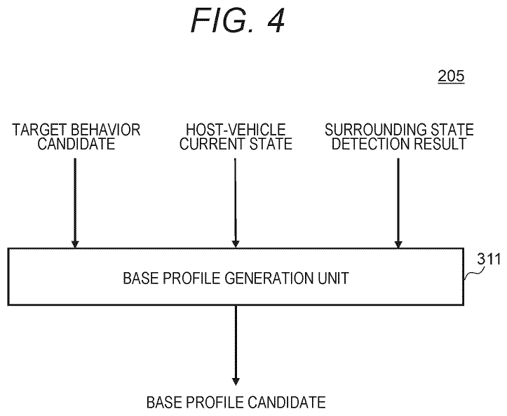

### FIG. 4

The base profile generation unit 311 generates an optimal trajectory candidate on the basis of a surrounding state detection result represented by information regarding roads around the host vehicle (the road information, the traffic light information, the traffic rule information, and the point group information) stored in the storage unit 308 of the risk map generation unit 205 in FIG. 3 or the map information processed by the map information processing unit 306, a current state of the host vehicle processed by the self-position estimation processing unit 310, and a target behavior candidate that is route information stored in the storage unit 308.

At this time, the base profile generation unit 311 determines various possible behaviors (target behavior candidates) taken by the host vehicle during automatic driving, for example, keeping the current lane of the host vehicle (Lane Keep (LK)), changing a lane from a lane in which the host vehicle is currently traveling to an adjacent lane (Lane Change (LC)), and avoiding an obstacle present ahead (Obstacle Avoidance (OA)), and generates a trajectory candidate corresponding to each of these target behavior candidates. Then, the base profile generation unit 311 generates base profile candidates (travel profile information) representing the travel state of the host vehicle in each generated trajectory candidate. That is, the base profile generation unit 311 takes on the role of a travel profile information generation unit.

Note that the travel profile information includes at least one of host vehicle speed profile information indicating a travel speed of the host vehicle in each trajectory candidate and host vehicle steering angle profile information indicating a steering amount of the host vehicle in each trajectory candidate.

Accordingly, in addition to the information from the three-dimensional object behavior prediction unit 307 that determines the surrounding moving object in a constant speed state, a plurality of base profile candidates generated on the basis of a plurality of assumed behaviors in different states are input to the map generation unit 309, so that it is possible to generate a risk map capable of displaying a risky spot even in a state where the surrounding environment of the host vehicle is uncertain, as compared with the conventional risk map using the constant speed assumption or the like, and the accuracy of searching for the optimal trajectory of the host vehicle is improved.

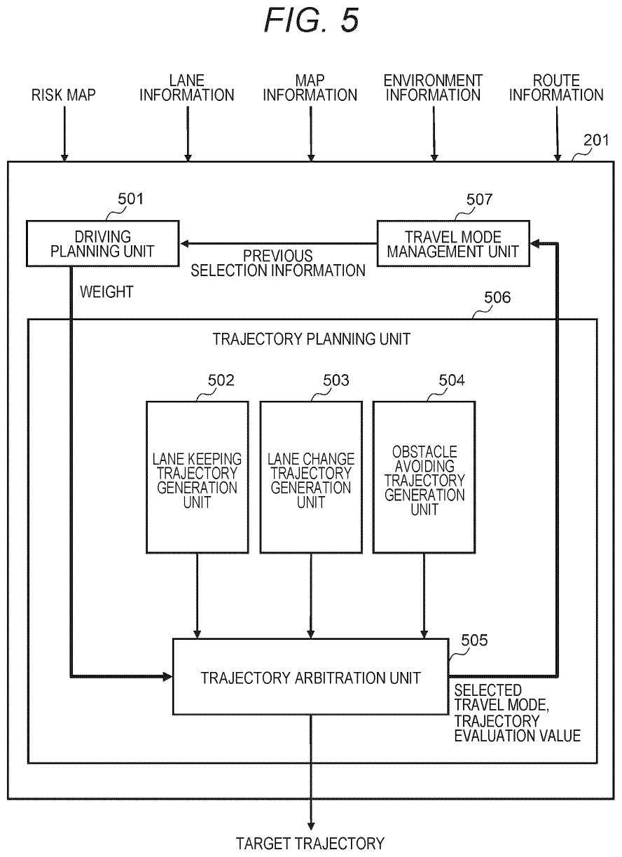

### FIG. 5

On the basis of the risk map generated by the risk map generation unit 205, and the road information, the traffic light information, the route information, the traffic rule information, and the point group information stored in the storage unit 308 of the risk map generation unit 205, the automatic driving planning unit 201 calculates a driving plan (a trajectory plan, a speed plan) in consideration of the ride comfort from the target trajectory of the host vehicle, collision determination, and the like.

The automatic driving planning unit 201 includes a driving planning unit 501, a trajectory planning unit 506, and a travel mode management unit 507. In addition, the trajectory planning unit 506 includes a lane keeping trajectory generation unit 502, a lane change trajectory generation unit 503, an obstacle avoiding trajectory generation unit 504, and a trajectory arbitration unit 505.

The driving planning unit 501 calculates a weight of a possible target behavior candidate of the host vehicle (hereinafter, a weight) on the basis of the risk map, the lane information, the map information, the route information, the environment information, and the like. The calculated weight is input to the trajectory arbitration unit 505 in the trajectory planning unit 506.

The weight will be described. The weight represents a degree of a possible behavior of the host vehicle, such as keeping the current lane of the host vehicle (Lane Keep (LK)), changing the current lane to an adjacent lane (Lane Change (LC)), or avoiding an obstacle present ahead (Obstacle Avoidance (OA)). For example, when the host vehicle travels on a straight road, in a situation where there is no another vehicle or object that the host vehicle needs to avoid ahead and it is determined from the route information that there is no need to change a lane to an adjacent lane, the weight is LK=100, LC=0, and OA=0. The value of this weight is a course change priority indicating the degree of priority of the course change of the host vehicle.

The trajectory planning unit 506 generates a trajectory (a lane keeping trajectory, a lane change trajectory, an obstacle avoiding trajectory) corresponding to each target behavior candidate. Each will be described. The lane keeping trajectory generation unit 502 generates, as the lane keeping trajectory, a trajectory for keeping the center of the lane in which the host vehicle is currently traveling. The lane change trajectory generation unit 503 generates a trajectory for performing a lane change to the adjacent lane of the lane in which the host vehicle is currently traveling (not only a change to the adjacent lane but also all course changes to deviate from the lane of the host vehicle). The obstacle avoiding trajectory generation unit 504 generates, as the obstacle avoidance trajectory, a travel trajectory for avoiding an obstacle object when the obstacle object is present in the lane in which the host vehicle is currently traveling.

The trajectory arbitration unit 505 evaluates the lane keeping trajectory, the lane change trajectory, and the obstacle avoiding trajectory input from the lane keeping trajectory generation unit 502, the lane change trajectory generation unit 503, and the obstacle avoiding trajectory generation unit 504 on the basis of the risk map generated by the risk map generation unit 205 and indicating the travel safety degree of the host vehicle for each position around the host vehicle and the weight input from the driving planning unit 501, and decides the target trajectory by selecting the trajectory with the best evaluation value. Then, the decided target trajectory is output to the vehicle control device 1 to cause the host vehicle to autonomously travel along the target trajectory, and an evaluation value for each trajectory and a selected travel mode representing a target behavior candidate corresponding to the selected target trajectory are output to the travel mode management unit 507.

The travel mode management unit 507 calculates previous selection information necessary for calculating a weight (course change priority) in the next sampling time, on the basis of the selected travel mode input from the trajectory arbitration unit 505 and the evaluation value of each trajectory. For example, in a case where the lane keeping trajectory is selected as the target trajectory on the basis of the evaluation values of LK=60, LC=40, and OA=0 in the trajectory arbitration unit 505, the previous selection information is generated on the basis of the traffic information (including traffic jam and the stop position of a failed vehicle) such that the possibility that the lane keeping trajectory is selected also in the next sampling time becomes high (such that a similar behavior continues).

The generated previous selection information is input to the driving planning unit 501. In this way, a driving plan in which the speed of the host vehicle is assumed to be within a predetermined range can be achieved in the driving planning unit 501 in consideration of the past base profile (previous selection information) and the base profile (travel profile information) newly input simultaneously with the input of the risk map.

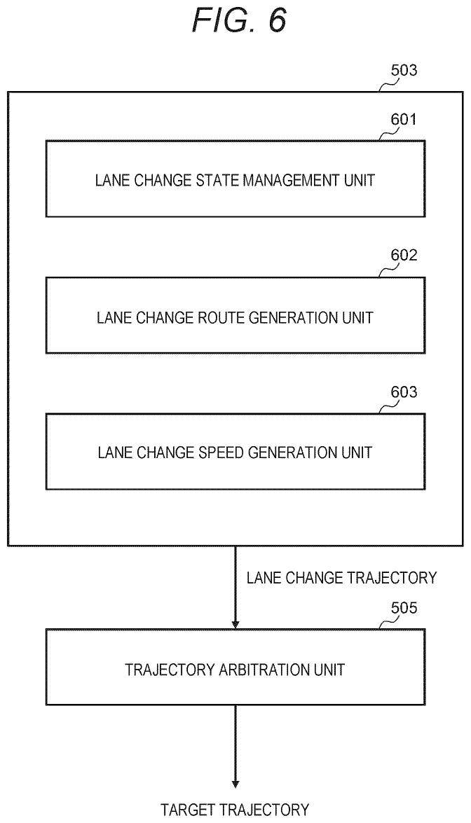

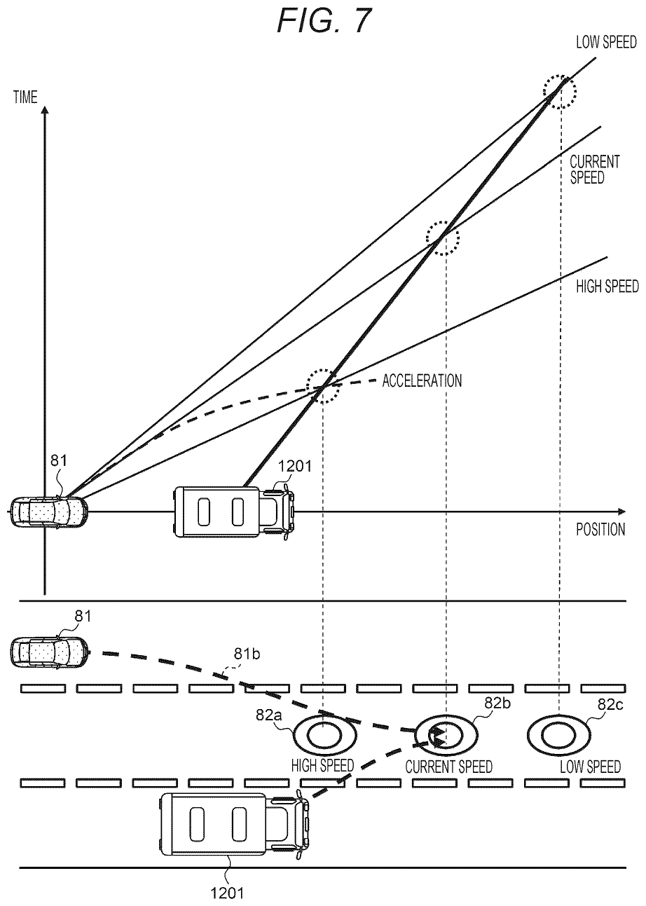

### FIGS. 6 and 7

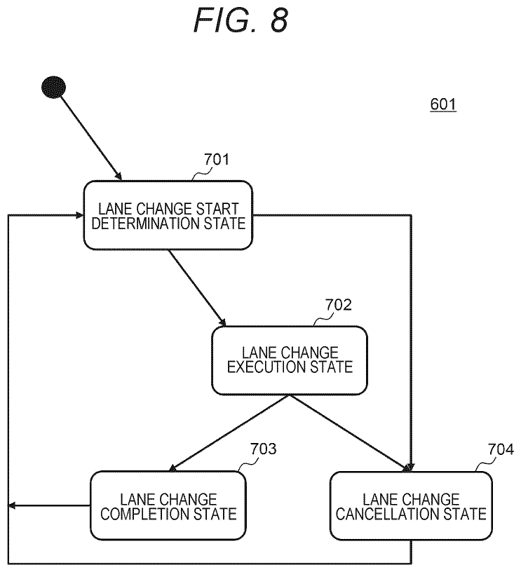

The lane change trajectory generation unit 503 included in the automatic driving planning unit 201 includes a lane change state management unit 601, a lane change route generation unit 602, and a lane change speed generation unit 603. Details of the lane change state management unit 601 will be described later with reference to FIG. 8.

The lane change route generation unit 602 generates a target route 81b for the host vehicle 81 to change a lane on the basis of the lane change state managed by the lane change state management unit 601 (FIG. 7). As a method of generating the target route 81b, there is a method of generating a spline curve with respect to a target position.

A predicted arrival time or distance is important in a scene where a lane change is required. The predicted arrival time is, for example, a time or a distance to a scene where a lane change of the host vehicle 81 is required due to an obstacle in the same lane. When the distance to the scene is, for example, 1000 m and the traveling average speed of the host vehicle 81 up to the present time or the average speed of the traffic flow in the section is 20 m/s, the expected arrival time is 50 seconds. Such a value is calculated as a margin and used for the lane change decision.

With respect to the target route 81b generated by the lane change route generation unit 602, the lane change speed generation unit 603 calculates a speed profile when the vehicle 81 travels on the target route 81b. For example, in a case where the vehicle travels on the route for 5 seconds, time-series points of speed of 50 points at intervals of 0.1 seconds are calculated (indicated by solid lines and a dotted line in the graph represented by a position axis and a time axis in the upper part of FIG. 7).

As a method of calculating the speed profile of the lane change speed generation unit 603, for example, it is conceivable to generate a speed profile candidate that satisfies following Equation (2). Note that w4 to w6 in Equation (2) are weighting factors.

$$\begin{matrix}[ Mathematical Formula 1 ] & \\ Min \cdot {\int }_{t 1}^{t 2} [ w 4 {( longitudinal acceleration of host vehicle )}^{2} + w 5 {( lateral acceleration of host vehicle )}^{2} + w 6 {( speed limit - host vehicle speed )}^{2} ] dt & Equation ( 2 )\end{matrix}$$

When the lane change speed generation unit 603 calculating the speed profile, the trajectory planning unit 506 using the weight of the driving planning unit 501 that calculates the weight by using the previous selection information calculates the positions and ranges of risk areas 82a to 82c (displayed on the three-lane roadway in the lower part of FIG. 7).

In this manner, the current speed risk area 82b indicating an area where another vehicle is likely to collide in a case where the host vehicle changes a lane at the current speed (constant speed), the acceleration risk area 82a indicating an area where another vehicle is likely to collide in a case where the host vehicle accelerates and changes a lane, and the deceleration risk area 82c indicating an area where another vehicle is likely to collide in a case where the host vehicle decelerates and changes a lane are calculated, and a risk area corresponding to the target driving behavior of the host vehicle 81 can be used. Therefore, a search system for the target trajectory at the time of optimal lane change is improved.

Note that, for example, in the case of predicting whether the another vehicle 1201 will travel while keeping the current lane or change the lane, the decision of the target trajectory may be made by inputting image information, statistical information (such as vehicle arrangement and obstacle arrangement), or the like to the neural network and calculating relative probabilities for a plurality of candidates.

For example, as the output result thereof, in a case where the lane change probability of the another vehicle 1201 within 5 seconds is 60%, the current lane keeping probability is 30%, and the other probability is 10%, the reliability regarding the lane change of the another vehicle 1201 is determined to be 60%. At this time, in a case where there is an obstacle in the same lane, the priority of the lane change (LC) increases as approaching the obstacle. By calculating such a degree of prediction reliability, a risk area can be newly generated for an object that arrives at a predetermined distance and time.

In a case where in the reliability determined in this manner, a behavior with the high reliability regarding the lane change of the another vehicle 1201 and a desired behavior of the host vehicle 81 interfere with each other (a scene where both vehicles change lanes to the center lane), it is possible to generate a plurality of risk areas in order to expand options for the host vehicle to change a lane.

In a case where the course change priority is lower than a predetermined standard, a constant speed assumed profile in which the host vehicle is assumed to move at a constant speed may be generated as the travel profile information, and in a case where the course change priority is higher than the predetermined standard, an acceleration profile in which the host vehicle is assumed to accelerate and a deceleration profile in which the host vehicle is assumed to decelerate may be generated as the travel profile information.

### FIG. 8

The lane change state management unit 601 in FIG. 6 will be described. The lane change state management unit 601 is a unit that manages a state (lane change state) of the host vehicle at the time of lane change to an adjacent lane. The lane change state management unit 601 manages the lane change state by setting the state of the host vehicle at the time of lane change to one of a lane change start determination state 701, a lane change execution state 702, a lane change completion state 703, and a lane change cancellation state 704.

When the operation of the automatic driving planning unit 201 is started, the lane change state management unit 601 sets the lane change state to the lane change start determination state 701. Thereafter, in a case where it is determined that the lane change of the host vehicle 81 is possible, the state transitions to the lane change execution state 702, and otherwise, the state transitions to the lane change cancellation state 704. In the lane change execution state 702, in a case where the lane change is completed, the state transitions to the lane change completion state 703, and in a case where it is determined that the lane change is impossible or a case where it is determined that the environmental condition or the like changes during the lane change and the lane change is impossible, the state transitions to the lane change cancellation state 704. After the lane change completion state 703 and the lane change cancellation state 704 are entered, the state returns to the lane change start determination state 701.

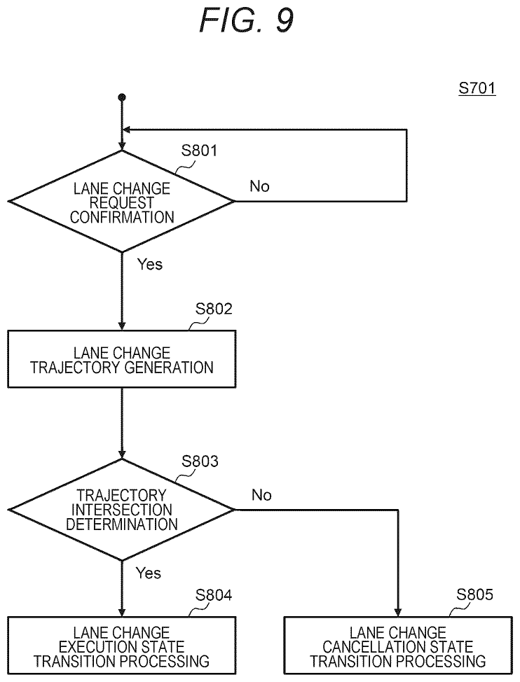

### FIG. 9

Processing executed in the lane change trajectory generation unit 503 will be described. In a case where the lane change state of the host vehicle managed by the lane change state management unit 601 transitions to the lane change start determination state S701, the processing flow of FIG. 9 is started, and the process proceeds to a lane change request confirmation step S801. In the lane change request confirmation step S801, if the weight value of LC among the weights of the respective target behaviors generated by the driving planning unit 501 is equal to or greater than a predetermined value, the process proceeds to a lane change trajectory generation step S802, and if not, step S801 is repeated.

In the lane change trajectory generation step S802, a trajectory necessary for lane change of the host vehicle is generated by using the lane change route generation unit 602 and the lane change speed generation unit 603.

Next, in a trajectory intersection determination step S803, a determination is performed on overlap between the risk map generated by the risk map generation unit 205 and the lane change trajectory generated in the lane change trajectory generation step S802. If it is determined that there is no overlap, the process proceeds to a lane change execution state transition processing step S804, and if it is determined that there is overlap, the process proceeds to a lane change cancellation state transition processing S805. In each transition processing, the lane change state management unit 601 causes the lane change state to transition on the basis of the state transition diagram illustrated in FIG. 7, and performs processing according to the lane change state after the transition.

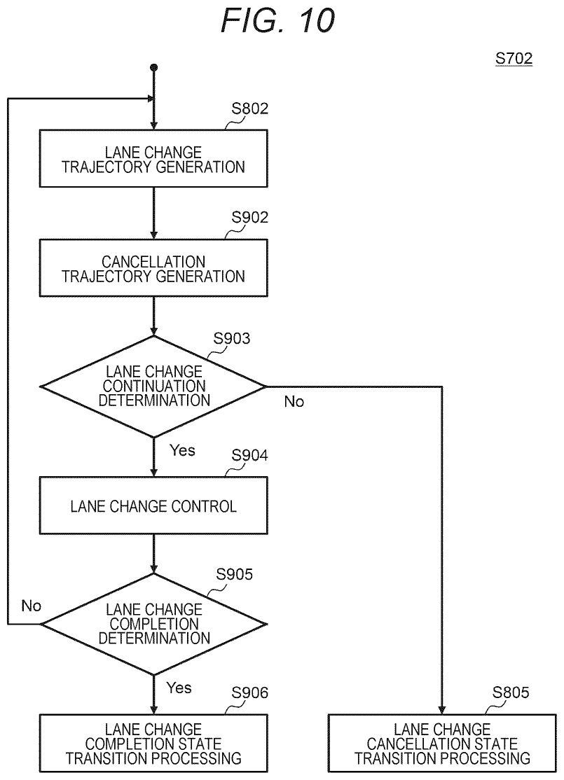

### FIG. 10

When the lane change state of the host vehicle managed by the lane change state management unit 601 transitions to the lane change execution state S702 in the lane change execution state transition processing step S804 of FIG. 9, the lane change trajectory generation unit 503 starts the processing flow of FIG. 10 and executes the lane change trajectory generation step S802. Subsequently, a cancellation trajectory generation step S902 is executed. In the cancellation trajectory generation step S902, a trajectory for canceling the lane change from the current position and returning to the original lane is generated by using the lane change route generation unit 602 and the lane change speed generation unit 603 (FIG. 6).

Subsequently, the process proceeds to a lane change continuation determination step S903, the generated lane change trajectory and cancellation trajectory are compared, and evaluation is performed on the basis of indices of safety and ride comfort. For example, in a case where the host vehicle is caused to travel on the basis of the lane change trajectory and it is expected that the host vehicle may suddenly approach another vehicle or a surrounding object, it is determined that the lane change cannot be continued, and the process proceeds to the lane change cancellation state transition processing step S805. On the other hand, in a case where it is determined that the lane change can be continued, the process proceeds to a lane change control step S904.

In the lane change control step S904, the generated lane change trajectory is transmitted to the trajectory arbitration unit 505, and in a case where the trajectory is selected by the trajectory arbitration unit 505, each actuator command value is created so as to follow the trajectory, and the lane of the host vehicle 81 is changed.

In a lane change completion determination step S905, it is determined for the position of the host vehicle whether the lane change to the adjacent lane has been completed, on the basis of the self-position information, the lane information, and the like. If it is determined as completed, the process proceeds to a lane change completion state transition processing step S906, and if it is determined as not completed, the lane change trajectory generation step S802 is executed again.

In the lane change completion state transition processing step S906, the lane change state management unit 601 causes the lane change state to transition to the lane change completion state S703 on the basis of the state transition diagram illustrated in FIG. 7, and performs processing according to the lane change state after the transition.

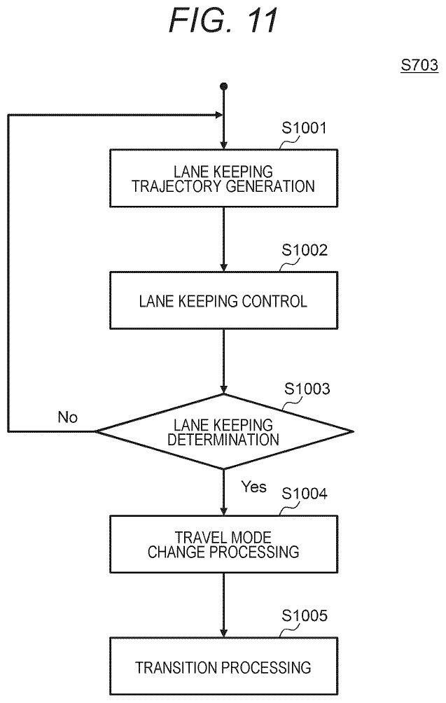

### FIG. 11

When the lane change state of the host vehicle managed by the lane change state management unit 601 transitions to the lane change completion state S703 in the lane change completion state transition processing step S906 in FIG. 10, the lane change trajectory generation unit 503 starts the processing flow of FIG. 11 and executes a lane keeping trajectory generation step S1001. Here, a trajectory for keeping the position of the host vehicle in the current lane is generated by using the lane change route generation unit 602 and the lane change speed generation unit 603 (FIG. 7).

Next, a lane keeping control step S1002 is executed. In the lane keeping control step S1002, the generated lane keeping trajectory is transmitted to the trajectory arbitration unit 505, and in a case where the trajectory is selected by the trajectory arbitration unit 505, each actuator command value is created so as to follow the trajectory, and the host vehicle is caused to keep the lane.

Next, a lane keeping determination step S1003 is executed. Here, it is determined whether the current lane can be kept, it is determined whether the lane can be kept for a predetermined time, and if it is determined that the lane can be kept, the process proceeds to a travel mode change processing step S1004, and if not, the lane keeping trajectory generation step S1001 is repeated. In the travel mode change processing step S1004, the travel mode is changed to lane keeping, and the process proceeds to a transition processing step S1005. In the transition processing step S1005, the lane change state management unit 601 causes the lane change state to transition to the lane change start determination state S701, on the basis of the state transition diagram illustrated in FIG. 8.

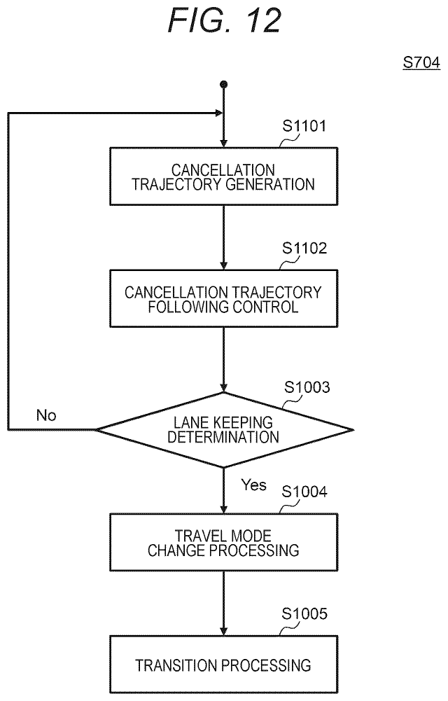

### FIG. 12

When the lane change state of the host vehicle managed by the lane change state management unit 601 transitions to the lane change cancellation state S704 in the lane change cancellation state transition processing step S805 in FIG. 9 or 10, the lane change trajectory generation unit 503 starts the processing flow in FIG. 12 and executes a cancellation trajectory generation step S1101. In the cancellation trajectory generation step S1101, a trajectory for returning the position of the host vehicle to the original lane is generated by using the lane change route generation unit 602 and the lane change speed generation unit 603 (FIG. 6).

Next, a cancellation trajectory following control step S1102 is executed. In the cancellation trajectory following control step S1102, the generated cancellation trajectory is transmitted to the trajectory arbitration unit 505 (FIG. 5), and in a case where the trajectory is selected by the trajectory arbitration unit 505, each actuator command value is created so as to follow the trajectory, and the host vehicle is caused to return to the original lane. Steps S1003 to S1005 are similar to those in FIG. 11.

In this way, the depth degree of a search for the optimal target route can be changed on the basis of the prediction reliability and the course change priority, and as compared with the related art, there is a margin due to the predicted arrival time and distance to the point where the course change of the host vehicle 81 occurs. Thus, it is possible to prevent unnecessary lane change operation of the host vehicle, reduce the deceleration frequency of the host vehicle and surrounding vehicles, and reduce a vehicle steering amount, thereby preventing the deterioration of ride comfort.

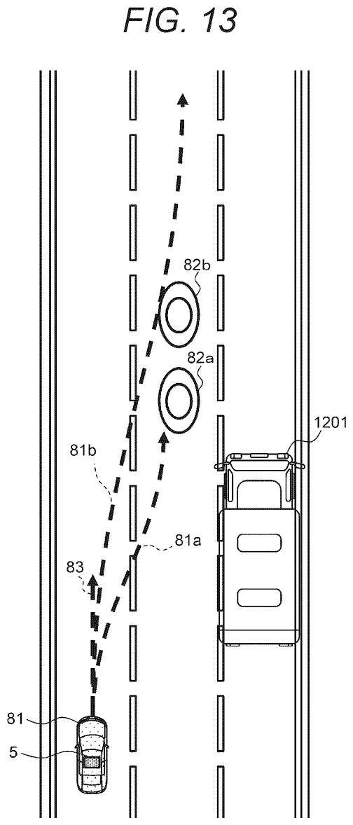

### FIG. 13

The lane change when the another vehicle 1201 is present will be specifically described (briefly described above in FIG. 7). Note that the road is assumed to have three lanes. In this scene, the host vehicle 81 is autonomously traveling in a left end lane, and the another vehicle 1201 is traveling in a right end lane on the right front side of the host vehicle 81.

The sensor 5 included in the host vehicle 81 detects the surroundings of the traveling host vehicle 81. In the host vehicle 81, the vehicle control device 1 generates, as the target behavior candidates, two behavior candidates of traveling while keeping the current lane (left end) or changing the lane to an adjacent lane, on the basis of the map information stored in the storage unit 308 and the environment information from the sensor 5 that perceives the surroundings.

In addition, for the target behavior candidates for lane change, a current speed risk map for traveling at a substantially constant speed (current speed) at the current vehicle speed of the host vehicle 81 for a future time and an acceleration risk map for accelerating to a speed higher than the current vehicle speed are generated on the basis of the base profile.

Here, as described above with reference to FIG. 7, two risk maps of the risk area 82b in the case of substantially constant speed and the risk area 82a in the case of acceleration are calculated as areas having a high risk of collision with the another vehicle 1201 in the cases of substantially constant speed and acceleration. By using these two risk maps, a trajectory for changing a lane at a substantially constant speed and a trajectory for changing a lane with acceleration are generated.

As a result of the calculation, the trajectory in the case of substantially constant speed is a first lane change trajectory 81b, and the trajectory in the case of acceleration is a second lane change trajectory 81a. Here, the degree of overlap between the lane change trajectories 81a and 81b and the risk areas 82a and 82b is examined.

In a case where a predetermined degree of overlap is satisfied as a result of examining the degree of overlap, the host vehicle 81 and the another vehicle 1201 may collide with each other, so that it is determined that the lane change is not possible, and the host vehicle 81 travels along the lane trajectory 83 traveling in the same lane. In addition, in a case where the predetermined overlapping condition is not satisfied as a result of the examination, and the lane change of the host vehicle is possible, the host vehicle 81 is controlled to follow the second lane change trajectory 81a or 81b, and the lane change is executed.

In this way, even if the another vehicle 1201 traveling in the right end lane changes the lane to a center lane, the host vehicle 81 does not approach the another vehicle 1201, and rapid acceleration/deceleration of the host vehicle 81 is not performed. Thus, the deterioration of ride comfort can be prevented.

Note that assuming that the another vehicle 1201 is a vehicle loaded with a load on a loading platform such as a truck, an unmanned driving vehicle, or the like, the risk map may be generated by changing a predetermined threshold of the overlapping condition so as to prevent damage to the host vehicle 81 due to an object other than the vehicle.

### SECOND EMBODIMENT

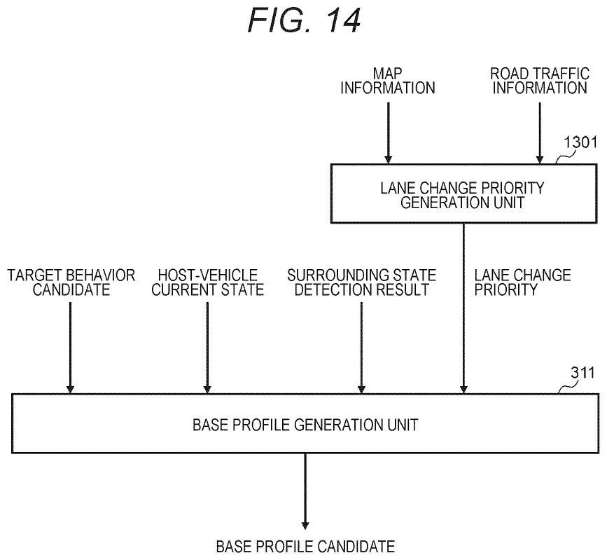

### FIG. 14

The base profile generation unit 311 is different from that of the first embodiment in that the base profile is generated by further inputting a lane change priority generated by a lane change priority generation unit 1301 on the basis of the map information and road traffic information.

For example, when the margin (see FIGS. 6 and 7) calculated for deciding a lane change decreases, a rate of generated lane change trajectories increases in the lane change route generation unit 602 of the lane change trajectory generation unit 503, and the lane change priority based on the weight of the driving planning unit 501 using the previous selection information increases. When the lane change priority increases, the base profile generation unit 311 adjusts the number of base profiles on the basis of the lane change priority, and thus the base profile to be generated increases as the lane change priority increases. The lane change priority is determined on the basis of, for example, traffic information communicated between vehicles.

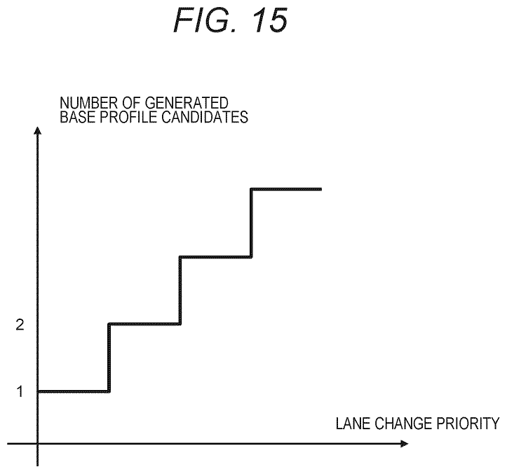

### FIGS. 15, 16, and 17

As illustrated in the biaxial graph of FIG. 15, the number of base profile candidates generated by the base profile generation unit 311 is determined on the basis of the lane change priority. In a case where the lane change priority generated by the lane change priority generation unit 1301 is low, the base profile generation unit 311 generates the same number of base profiles as the number of behavior candidates, and generates a plurality of base profiles for each behavior candidate as the lane change priority becomes higher. Accordingly, as the necessity of lane change increases, a plurality of base profiles are prepared for optimal lane change, so that it is possible to generate a risk map based on the base profiles, and it is possible to respond to the lane change of the host vehicle even in a certain situation.

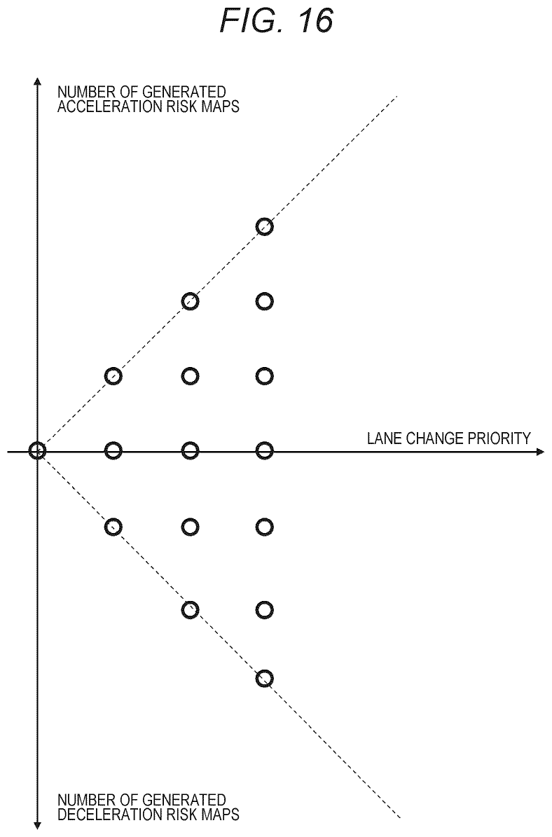

In addition, as illustrated in FIG. 16, the number of generated acceleration risk maps and the number of generated deceleration risk maps may be also increased similarly on the basis of the lane change priority.

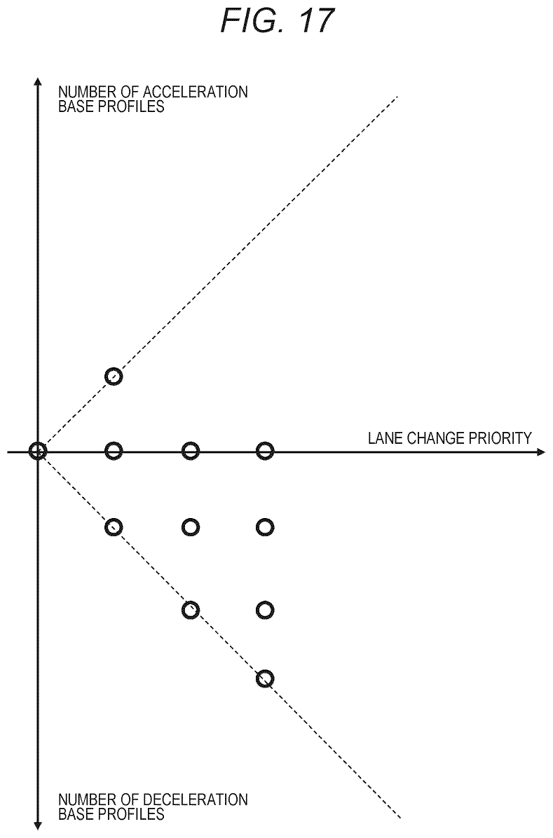

In addition, unlike FIG. 16, as illustrated in FIG. 17, the number of base profiles may be increased or decreased on the basis of the lane change priority according to the speed, such that the base profiles are generated with priority given to the number of deceleration base profiles over the number of acceleration base profiles. Note that the reason why the deceleration base profile is preferentially generated in this manner is that it is determined that the possibility of lane change becomes higher when the host vehicle decelerates than when the host vehicle accelerates.

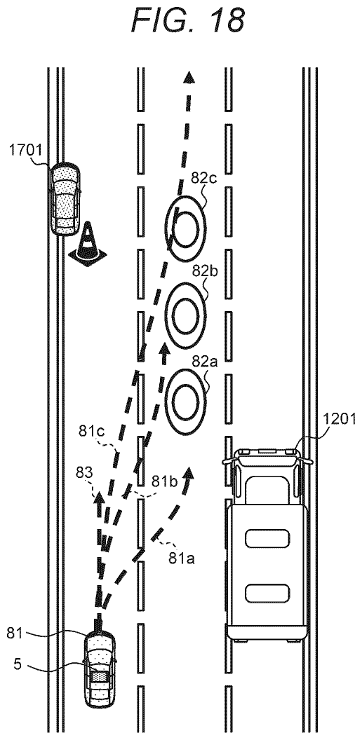

### FIG. 18

A lane change in a case where a stopped vehicle 1701 is stopped in the same lane will be described. The sensor 5 mounted on the host vehicle 81 detects that there is the stopped vehicle 1701 in the same lane as the left end lane in which the host vehicle 81 travels. The host vehicle 81 needs to change a lane to the center lane in order to avoid the stopped vehicle 1701.

Note that the presence of the stopped vehicle 1701 includes not only direct detection by the sensor 5 but also detection by obtaining information in advance through a line such as a network or communication means from the vicinity of the stopped vehicle 1701.

In a case where the host vehicle 81 attempts lane change, for example, when attempting to generate the lane change trajectory 81b and the lane change trajectory 81a at a substantially constant speed and acceleration (first embodiment), it is determined on the basis of the intersection determination of the trajectories that the lane change at a substantially constant speed or acceleration is not possible (see FIG. 9).

Accordingly, the lane change priority further increases, the number of deceleration base profiles increases (see FIG. 17), and a plurality of deceleration risk maps based on the increased number of generated deceleration base profiles are generated. An area determined to have a high risk by the deceleration risk map is defined as the risk area 82c. In addition, the lane change trajectory 81c for deceleration is generated.

Then, the lane change trajectories 81a, 81b, and 81c for acceleration, substantially constant speed, and deceleration are compared with the risk maps 82a, 82b, and 82c, respectively, and a predetermined overlapping condition is determined for each. In a case where the predetermined overlapping condition is satisfied (the lane change trajectory and the risk map intersect), the lane change is not possible. In a case where the predetermined overlapping condition is not satisfied (the lane change trajectory and the risk map do not intersect), the lane change is executed. In a case where the lane change at a substantially constant speed or with acceleration is not possible as described above, the host vehicle 81 is controlled to follow the lane change trajectory 81c for deceleration and performs the lane change.

Note that, for example, when the host vehicle 81 is signaling with a direction indicator or the like and receives honking from the another vehicle 1201, there is a possibility that the another vehicle 1201 is warning (suppressing) the lane change. In this case, in addition to the radar 301 and the stereo camera 302, a vehicle exterior microphone or the like may be attached as a sensor of the host vehicle, and by taking in information from a device that senses vehicle exterior sound, the risk map generation unit 205 may further preferentially generate the risk map for deceleration. In this way, it becomes possible to perform the lane change even in a situation where the lane change of the host vehicle 81 is impossible due to the presence of the another vehicle 1201, and the convenience of a lane change function is improved.

In addition, the risk map may be switched from the automatic driving in a case where the driver operates a steering wheel (override), that is, in a case where the acceleration (or deceleration) intention of the driver is input to the system by an accelerator (or brake) pedal operation of the driver, so that the generation of the risk map increases accordingly. For example, a method of switching to concentrate on generation of a risk map for overtaking when the accelerator is stepped on and to concentrate on generation of a risk map for preceding another vehicle running in parallel when the brake is applied is generated in the system.

In this override, the driver may cancel the automobile line change by a lane change cancel button or a blinker operation. In addition, even in a case where the risk map is generated according to the intention of the driver, when it is determined that the lane change is difficult (there is a risk of collision with another vehicle), the content of the determination may be notified to a display or the like to cancel the automobile line change.

### First Modification

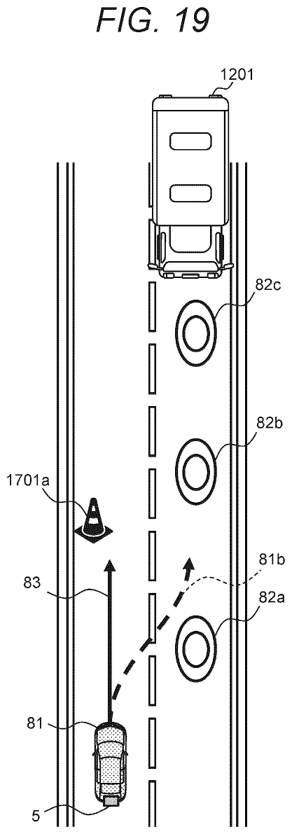

### FIG. 19

The present invention is applied assuming a two-lane road. In FIG. 19, there is an obstacle 1701a in the lane in which the host vehicle 81 travels, and thus the host vehicle 81 needs to change the lane, but the another vehicle 1201 is traveling facing the host vehicle 81 from the opposite lane. At this time, the risk area 82b is calculated in a case where the host vehicle 81 is at a substantially constant speed, the risk area 82a is calculated in a case where the host vehicle accelerates, and the risk area 82c is calculated in a case where the host vehicle decelerates.

In such a case, without involving the lane change of the another vehicle 1201, the host vehicle 81 changes the risk map to be generated, on the basis of the prediction result (travel profile information) of acceleration, deceleration, and constant speed. In addition, in a case where it is determined that the lane change of the host vehicle 81 is difficult even with the newly created risk map, the host vehicle takes a traveling behavior of stopping before the obstacle 1701a.

As another case of the first modification, for example, in a case where the obstacle 1701a in the lane in which the host vehicle 81 travels is another vehicle that precedes the host vehicle 81 at a low speed, it is determined whether to overtake the preceding vehicle or continue following the preceding vehicle in a situation where there is an opposing vehicle also in the opposite lane. In this case, as the method of switching base profiles, in addition to the constant speed, the acceleration, and the deceleration, patterns of overtaking a preceding vehicle and following a preceding vehicle may be provided in the driving behavior plan, a risk map and a target trajectory may be generated in each of the patterns and may be evaluated by the arbitration unit to determine whether it is better for the host vehicle to overtake or follow.

### Second Modification

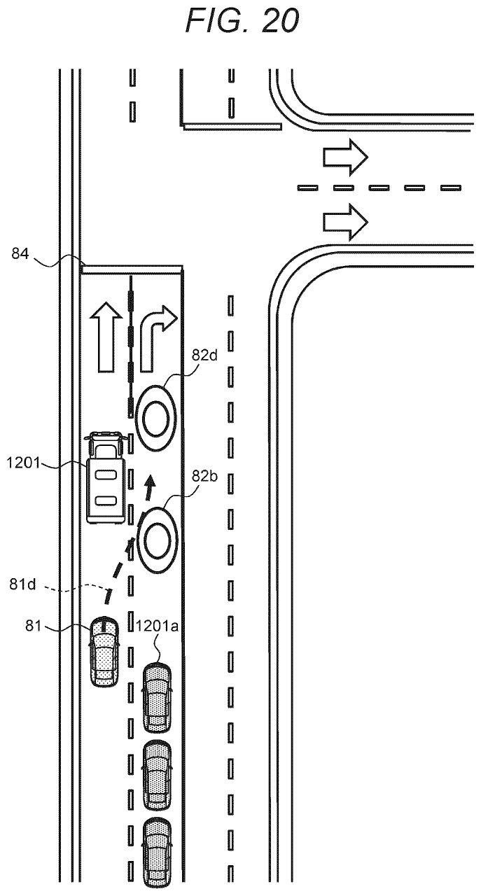

### FIG. 20

The present invention is applied assuming a road having four lanes and a T-junction. In FIG. 20, the another vehicle 1201 is in the same left end lane as that of the host vehicle 81. In an adjacent lane, a second another vehicle 1201a is traveling side by side behind the host vehicle 81. At this time, when the host vehicle 81 takes a behavior to change a lane to the adjacent lane, the risk area 82b is calculated in the case of substantially constant speed, and the risk area 82d is calculated in the case of decelerating to change a lane before the stop line.

Specifically, since the adjacent lane is a right-turn lane of the upcoming intersection, a risk map for deceleration involving stopping needs to be generated at the time of lane change. Even in a case where the lane change is difficult with the current vehicle arrangement, it is necessary to ask another vehicle 1201a to yield the lane. Therefore, the vehicle 81 starts the lighting time of the direction indicator earlier to light the direction indicator for a longer time, and generates the risk map for deceleration.

Note that the possible traveling behaviors of the host vehicle 81 may include a traveling behavior of maneuvering in the same lane in addition to the lane change and the timing control of the blinker.

According to the first and second embodiments of the present invention described above, the following operational effects are exhibited.

(1) A vehicle control device 1 of the present invention includes: a travel profile information generation unit 311 that generates travel profile information indicating a travel state of a host vehicle 81 for each of a plurality of possible target behavior candidates taken by the host vehicle 81; a three-dimensional object behavior prediction unit 307 that predicts an behavior of a three-dimensional object existing around the host vehicle 81; a risk map generation unit 205 that generates a risk map indicating a travel safety degree of the host vehicle 81 for each position around the host vehicle 81 on the basis of a prediction result of the behavior of the three-dimensional object by the three-dimensional object behavior prediction unit 307 and the travel profile information; a driving planning unit 201 that calculates, for each of the plurality of target behavior candidates, a priority indicating a degree to which the host vehicle 81 is to preferentially make a selection; and a trajectory arbitration unit 505 that selects, as a target trajectory of the host vehicle 81, a trajectory corresponding to one of the plurality of target behavior candidates on the basis of the risk map and the priority. With this configuration, it is possible to provide the vehicle control device 1 capable of achieving both safety and ride comfort of the automatic driving vehicle and performing automatic driving with improved reliability.

(2) On the basis of the travel profile information and surrounding environment information, the driving planning unit 201 considers an expected arrival time, which is calculated by the driving planning unit 201, to a point where a course change of the host vehicle 81 occurs, and sets a higher course change priority as the expected arrival time decreases. With this configuration, it is possible to reliably change the lane of the automatic driving vehicle in a case where there is an obstacle in the same lane.

(3) The travel profile information generation unit 311 generates the travel profile information having different conditions regarding a speed of the host vehicle 81, on the basis of the course change priority. With this configuration, it is possible to generate respective risk maps corresponding to different speeds.

(4) In a case where the course change priority is lower than a predetermined standard, the driving planning unit 201 generates, as the travel profile information, a constant speed assumed profile in which the host vehicle 81 is assumed to move at a constant speed, and in a case where the course change priority is higher than the predetermined standard, the driving planning unit 201 generates, as the travel profile information, an acceleration profile in which the host vehicle 81 is assumed to accelerate and a deceleration profile in which the host vehicle 81 is assumed to decelerate. With this configuration, it is possible to generate respective risk maps corresponding to different speed profiles.

(5) The risk map generation unit 205 generates a risk map in accordance with lighting timing of a direction indicator of a vehicle 1201 other than the host vehicle 81. With this configuration, a more optimal risk map can be generated.

(6) The travel profile information includes at least one of host vehicle speed profile information that is an element for achieving a target behavior of the host vehicle 81 and host vehicle steering angle profile information indicating a steering amount of the host vehicle. With this configuration, the travel profile information necessary for the risk map can be generated.

(7) The risk map generation unit 205 calculates the prediction reliability on the basis of the surrounding environment information and past statistical information by a neural network model. With this configuration, determination on whether to give priority to course change can be optimized from the information of the surrounding environment.

Note that the present invention is not limited to the above embodiments, and various modifications and other configurations can be combined without departing from the gist of the present invention. In addition, the present invention is not limited to one including all the configurations described in the above embodiments, and includes one in which a part of the configuration is deleted.

### REFERENCE SIGNS LIST

1 vehicle control device
2 to 5 sensor
8 steering control device
15 braking control device
19 acceleration control device
23 communication device
24 display device
81 host vehicle
201 automatic driving planning unit
202 automatic parking planning unit
203 vehicle movement control unit
204 actuator control unit
205 risk map generation unit
206 vehicle network
301 radar
302 stereo camera
303 vehicle sensor
305 sensor information processing unit
306 map information processing unit
307 three-dimensional object behavior prediction unit
308 storage unit
309 map generation unit
310 self-position estimation processing unit
311 base profile generation unit
501 driving planning unit
502 lane keeping trajectory generation unit
503 lane change trajectory generation unit
504 obstacle avoiding trajectory generation unit
505 trajectory arbitration unit
601 lane change state management unit
602 lane change route generation unit
603 lane
1201 another vehicle

1. A vehicle control device comprising:
a travel profile information generation unit that generates travel profile information indicating a travel state of a host vehicle for each of a plurality of possible target behavior candidates taken by the host vehicle;
a three-dimensional object behavior prediction unit that predicts a behavior of a three-dimensional object existing around the host vehicle;
a risk map generation unit that generates a risk map indicating a travel safety degree of the host vehicle for each position around the host vehicle on a basis of a prediction result of the behavior of the three-dimensional object by the three-dimensional object behavior prediction unit and the travel profile information;
a driving planning unit that calculates, for each of the plurality of target behavior candidates, a priority indicating a degree to which the host vehicle is to preferentially make a selection; and
a trajectory arbitration unit that selects, as a target trajectory of the host vehicle, a trajectory corresponding to one of the plurality of target behavior candidates on a basis of the risk map and the priority.

2. The vehicle control device according to claim 1, wherein on a basis of the travel profile information and surrounding environment information, the driving planning unit considers an expected arrival time, which is calculated by the driving planning unit, to a point where a course change of the host vehicle occurs and sets a higher course change priority as the expected arrival time decreases.

3. The vehicle control device according to claim 2, wherein the travel profile information generation unit generates the travel profile information having different conditions regarding a speed of the host vehicle on a basis of the course change priority.

4. The vehicle control device according to claim 3, wherein
in a case where the course change priority is lower than a predetermined standard, the driving planning unit generates, as the travel profile information, a constant speed assumed profile in which the host vehicle is assumed to move at a constant speed, and
in a case where the course change priority is higher than the predetermined standard, the driving planning unit generates, as the travel profile information, an acceleration profile in which the host vehicle is assumed to accelerate and a deceleration profile in which the host vehicle is assumed to decelerate.

5. The vehicle control device according to claim 1, wherein the risk map generation unit generates a risk map in accordance with lighting timing of a direction indicator of a vehicle other than the host vehicle.

6. The vehicle control device according to claim 1, wherein the travel profile information includes at least one of host vehicle speed profile information that is an element for achieving a target behavior of the host vehicle and host vehicle steering angle profile information indicating a steering amount of the host vehicle.

7. The vehicle control device according to claim 1, wherein the risk map generation unit calculates the prediction reliability on a basis of the surrounding environment information and past statistical information by a neural network model.
